(19) United States
(12) Patent Application Publication
(10) Pub. No.: US 2024/0263011 A1
(43) Pub. Date: Aug. 8, 2024

(54) COMPOSITIONS AND METHODS OF REDUCING AGGREGATION OF MOLECULES

(71) Applicant: Ludwig-Maximilians-Universitaet Muenchen, Muenchen (DE)

(72) Inventors: Wolfgang Friess, Seeshaupt (DE); Natalie Deiringe, Kastl (DE)

(21) Appl. No.: 18/557,303

(22) PCT Filed: May 10, 2022
(86) PCT No.: PCT/EP2022/062589

§ 371 Date: Oct. 26, 2023

(30) Foreign Application Priority Data
May 12, 2021 (EP) 21173556.8

(51) Int. Cl. C08L 83/12; C08G 77/46; C08L 23/16

(52) U.S. Cl. CPC C08L 83/12; C08G 77/46; C08L 23/16

(57) ABSTRACT

The disclosure provides compositions comprising an amphiphilic dimethylsiloxane block copolymer embedded within a rubber, wherein the rubber has an elongation at break greater than about 140%, and wherein the composition is in the form of a tubing, and methods of making and using such compositions to reduce biomolecule particle formation in samples.

### BACKGROUND

Processing large molecules, therapeutic products such as proteins and antibodies may cause particle formation which increases the risk of adverse immunogenicity in patients. Particle formation may occur during all stages of manufacturing but is particularly prominent during the final solution handling step—the filling pump operation where the final drug formulation is pumped through tubing and filled into vials. During pumping (e.g., peristaltic pumping), the large molecules likely form a film on the tubing surface and rupture of the film during the mechanical stress of pumping may release the particles. Control of this step is particularly important since it is the final manufacturing step before the first exposure of the drug to a patient.

Particle formation may be reduced by the presence of surfactants in solution which prevents protein adsorption and film formation on the tubing wall. Surfactant coatings on the tubings' inner surfaces have also been shown to suppress protein adsorption under static conditions but are unstable in an extensive shear environment as in pumping. The main challenges in any surface modification of tubing materials include (a) leaching of ingredients or coatings, (b) maintaining material integrity, (c) maintaining stability during high shear, and (d) avoiding negatively impacting the stability of the biomolecule in solution.

It is thus an object of the present disclosure to provide compositions, for instance, compositions in the form of a tubing, comprising an amphiphilic dimethylsiloxane block copolymer embedded within a rubber, wherein the rubber has an elongation at break greater than about 140% and methods of making and using such compositions to reduce biomolecule particle formation in samples. Further objects of the disclosure will be clear on the basis of the following description, examples and claims.

### SUMMARY

In a first aspect, the present disclosure relates to compositions, for instance, compositions in the form of a tubing, comprising an amphiphilic dimethylsiloxane block copolymer embedded within a rubber, wherein the rubber has an elongation at break greater than about 140%.

In a further aspect, the present disclosure relates to methods of making the compositions disclosed herein, such as compositions in the form of a tubing, comprising (a) contacting the rubber with a solution of the amphiphilic dimethylsiloxane block copolymer; and (b) removing the excess solution. The present disclosure also relates to compositions obtainable by said method.

In yet a further aspect, the disclosure relates to methods of processing an aqueous liquid composition comprising a biologically active large molecule, the method comprising the steps of: (a) providing the compositions disclosed herein in the form of a tubing; and (b) pumping the aqueous liquid composition through the tubing.

In yet a further aspect, the disclosure relates to methods of reducing aggregation of a biologically active large molecule in an aqueous liquid, the method comprising contacting the aqueous liquid with any of the compositions disclosed herein, for instance, compositions in the form of a tubing, wherein the method results in reduced aggregation of the biologically active large molecule compared with contacting the aqueous liquid with a rubber lacking the amphiphilic dimethylsiloxane block copolymer.

### DESCRIPTION OF THE DRAWINGS

FIG. 1 depicts the stress-strain curves for the dimethylsiloxane (ethylene oxide) block copolymers embedded in silicone rubber tubings versus unmodified rubber tubings prepared by the method described in Example 2. The “%” refers to “(weight/volume)”, “(wt./vol.)” or “(w/v)” calculated as the weight of copolymer dissolved in a volume of organic solvent used when preparing the modified rubber tubings. The modified tubings were synthesized by contacting a 2%, 5% or 10% (w/v) DBE-224, DBE-311, DBE-712 or DBE-814 dimethylsiloxane block copolymer solution with the silicone rubber tubings for 1.5, 3 or 5 hr as described in Example 2.

FIG. 2 depicts turbidity measurements (Formazin Nephelometric Units, “FNU”) and particle quantification by flow imaging data for a buffer solution or a 1 mg/ml monoclonal antibody solution formulated in said buffer solution pumped through modified silicone rubber tubings comprising embedded dimethylsiloxane (ethylene oxide) block copolymers or unmodified rubber tubings as described in Example 3. The modified tubings were synthesized by contacting a 5% (w/v) DBE-224, DBE-311, DBE-712 or DBE-814 dimethylsiloxane block copolymer solution with the silicone rubber tubings for 5 hr as described in Example 2.

FIG. 3 depicts turbidity measurements and particle quantification by flow imaging data over time for a buffer solution or a 1 mg/mL monoclonal antibody solution formulated in said buffer solution pumped through modified silicone rubber tubings comprising embedded DBE-712 dimethylsiloxane block copolymer or unmodified rubber tubings as described in Example 3. The modified tubings were synthesized by contacting a 5% (w/v) DBE-712 dimethylsiloxane block copolymer solution with the silicone rubber tubings for 5 hr as described in Example 2.

FIG. 4 depicts turbidity measurements and particle quantification by flow imaging for a buffer solution or a 1 mg/mL human growth hormone solution formulated in said buffer solution pumped through modified silicone rubber tubings comprising embedded DBE-712 dimethylsiloxane block copolymer or unmodified rubber tubings as described in Example 3. The modified tubings were synthesized by contacting a 5% (w/v) DBE-712 dimethylsiloxane block copolymer solution with the silicone rubber tubings for 5 hr as described in Example 2.

FIG. 5 depicts turbidity measurements and particle quantification by flow imaging data for a buffer solution or a 1 mg/mL monoclonal antibody solution formulated in said buffer solution pumped through ethylene propylene diene monomer (EPDM) rubber tubings comprising embedded DBE-712 dimethylsiloxane (ethylene oxide) block copolymer or unmodified rubber tubings as described in Example 6. The modified tubings were synthesized by contacting a 5% (w/v) solution of DBE-712 dimethylsiloxane block copolymer solution with the EPDM rubber tubings for 5 hr as described in Example 5.

### DETAILED DESCRIPTION

The objects are solved by the subject-matter of the independent claims. Advantageous embodiments are described in the dependent claims and subsequent description.

### Definitions

Introductorily, some definitions of terms are given which are used throughout the description and claims. The definitions should be used to determine the meaning of the respective expressions unless the context requires a different meaning.

The terms “a” or “an” do not exclude a plurality, i.e., the singular forms “a”, “an” and “the” should be understood as to include plural referents unless the context clearly indicates or requires otherwise. In other words, all references to singular characteristics or limitations of the present disclosure shall include the corresponding plural characteristic or limitation, and vice versa, unless explicitly specified otherwise or clearly implied to the contrary by the context in which the reference is made. The terms “a”, “an” and “the” hence have the same meaning as “at least one” or as “one or more” unless defined otherwise. For example, reference to “an ingredient” includes mixtures of ingredients, and the like.

The term “biologically active large molecule” refers to a macromolecule such as a protein, fusion protein, antibody, antibody conjugate, antibody fragment and the like that has a therapeutic effect in a subject.

The term “composition” refers to any type of composition in which the specified ingredients may be incorporated, optionally along with any further constituents.

The term “compound” refers to a chemical substance, which is a material consisting of molecules having essentially the same chemical structure and properties. For a small molecular compound, the molecules are typically identical with respect to their atomic composition and structural configuration. For a macromolecular or polymeric compound, the molecules of a compound are highly similar but not all of them are necessarily identical.

The terms “comprise”, “comprises” and “comprising” and similar expressions are to be construed in an open and inclusive sense, as “including, but not limited to”.

The term “elongation at break” means the percentage increase in length that a material such as a polymer will achieve before breaking. Elongation at break is typically measured using the standard test method ASTM D412 developed and published by ASTM International, specifically the test method version published in 2016.

The term “embedded” in the context of a block copolymer embedded within a rubber means that the block copolymer molecules are present and dispersed within the rubber matrix, and at least partially below the surface of the rubber matrix. The presence of embedded block copolymer may be determined by measuring leaching of the copolymer from the rubber matrix. Generally, embedded block copolymers leach from the rubber matrix at a level of 0.5 ppm or lower as measured by, for example, the technique described in Example 2.

The terms “essentially”, “about”, “approximately”, “substantially” and the like in connection with an attribute or value include the exact attribute or the precise value, as well as any attribute or value typically considered to fall within a normal range or variability accepted in the technical field concerned.

The terms, “one embodiment”, “an embodiment”, “a specific embodiment” and the like mean that a particular feature, property or characteristic, or a particular group or combination of features, properties or characteristics, as referred to in combination with the respective expression, is present in at least one of the embodiments of the disclosure. The occurrence of these expressions in various places throughout this description do not necessarily refer to the same embodiment. Moreover, the particular features, properties or characteristics may be combined in any suitable manner in one or more embodiments.

The term “room temperature” refers to a temperature ranging from 15° C. to 25° C., as is for instance defined by the European Pharmacopoeia or by the WHO guidance “Guidelines for the Storage of Essential Medicines and Other Health Commodities” (2003).

### Compositions and Methods of Preparing Compositions

Silicone tubing made of polydimethylsiloxane (PDMS) is one of the commonly used tubings in the context of peristaltic pumping of biological pharmaceuticals. But the biologically active large molecules commonly present in such biological pharmaceuticals have a strong tendency to adsorb to the hydrophobic PDMS surface. Use of hydrophilic tubings such as polyvinyl chloride (PVC) tubing had been previously reported to have problems with leaching of plasticizers. Without being bound by any theory, it was postulated that hydrophobic rubber materials may contribute to the unwanted aggregation of the biologically active large molecules present in the biological pharmaceutical product. Modification of polymeric surfaces to reach higher surface hydrophilicity resulting in lower protein adsorption has been established, for example, in microfluidic applications. A wide range of techniques such as plasma treatment, physisorption, grafting to or grafting from approaches, or coating with surfactants showed extensive reduction in protein adsorption by increasing the hydrophilicity of PDMS by modifying the PDMS surface. These surface modification results provided a natural starting point in investigating whether the same approaches could be applied in tubing materials. However, not all surface modification attempts of the inventors in tubing materials proved to be successful in reducing particle formation during pumping, as discussed in more detail below. The inventors' results demonstrate that the lessons learned from surface modification of PDMS materials may not necessarily transfer successfully when applied to tubing materials given the conditions required for pumping.

The inventors first attempted a hydrophilic surface modification of hydrophobic rubber compositions as described in Example 1 below. They investigated increasing the hydrophilicity of tubing materials, such as by oxidation of terminal methyl groups of silicone tubing with O₂ plasma, incubating the oxidized tubing with a polyethylene glycol silane in organic solvents, and evaporating the solvent. This method created a polyethylene glycol coating on the silicone tubing which provided the desired more hydrophilic surface, but which was abraded during pumping, leaching unwanted materials into the sample, and resulting in no reduction of particle levels. Thus, this surface coating which may additionally suffer from low scalability, limited shelf life, and/or a labour-intensive multistep modification process is not a viable approach to achieve the goal of a reduction of protein particle formation. Therefore, the inventors took an alternative approach to modify tubing surface hydrophilicity.

In the alternative approach, the inventors investigated embedding amphiphilic dimethylsiloxane block copolymers within a silicone or EPDM rubber composition as described in Examples 2-3 and 5-6 below. The inventors surprisingly found very low levels of leaching of material, good maintenance of the material integrity and stability of the rubber composition during high shear, and no negative impacts on the stability of the biomolecule in solution.

The inventors also investigated embedding various poloxamers within a rubber composition as described in Example 4. However, unlike the rubber compositions with embedded amphiphilic dimethylsiloxane block copolymers, pumping studies using a 1 mg/monoclonal antibody solution formulated in a buffer solution pumped through tubings of these poloxamer-embedded rubbers showed only modest to no reduction in biomolecule particle formation using poloxamer embedded rubber compositions. Therefore, to achieve the goal of a reduction of particle formation, these studies lead the inventors to discover tubings comprising an amphiphilic dimethylsiloxane block copolymer embedded within a rubber, wherein the rubber has an elongation at break greater than about 140%.

In a first aspect, the disclosure relates to compositions comprising an amphiphilic dimethylsiloxane block copolymer embedded within a rubber, wherein the rubber has an elongation at break greater than about 140%. Rubber materials having an elongation at break greater than about 140% may be formed into tubing materials to be used in pumping applications as disclosed herein. Other materials having an elongation at break lower than about 140% are generally not mechanically stable enough to be formed into tubing materials. In some embodiments, the rubber is a silicone rubber. In other embodiments, the silicone rubber is a platinum cured silicone rubber. In some embodiments, the rubber is an ethylene propylene diene monomer rubber. In other embodiments, the rubber is a vulcanized ethylene propylene diene monomer rubber. In yet other embodiments, the ethylene propylene diene monomer rubber comprises ethylene propylene diene monomer rubber particles encapsulated in a polypropylene matrix. In some embodiments, the composition is in the form of a solid composition. In other embodiments, the composition is in the form of an elastomeric composition. In yet other embodiments, the composition is in the form of a tubing.

In some embodiments of the first aspect, the amphiphilic dimethylsiloxane block copolymer comprises blocks of ethylene oxide, acrylic acid, or vinyl alcohol. In other embodiments, the amphiphilic dimethylsiloxane block copolymer comprises blocks of ethylene oxide. In some embodiments, the composition comprises from about 0.1 wt. % to about 5 wt. % of the amphiphilic dimethylsiloxane block copolymer. In other embodiments, the composition comprises from about 0.5 wt. % to about 1.5 wt. % of the amphiphilic dimethylsiloxane block copolymer. The wt. % is the wt. % of the amphiphilic dimethylsiloxane block copolymer in the tubing before drying. In some embodiments, the amphiphilic dimethylsiloxane block copolymer comprises a dimethylsiloxane (ethylene oxide) block copolymer. In other embodiments, the dimethylsiloxane (ethylene oxide) block copolymer comprises from about 25 to about 30 wt. % ethylene oxide, from about 30 to about 35 wt. % ethylene oxide, from about 60 to about 70 wt. % ethylene oxide, from about 75 to about 85 wt. % ethylene oxide, or about 80 wt. % ethylene oxide. In yet other embodiments, the dimethylsiloxane (ethylene oxide) block copolymer comprises from about 60 to about 70 wt. % ethylene oxide.

In other embodiments of the first aspect, the amphiphilic dimethylsiloxane block copolymer comprises a compound of formula I:

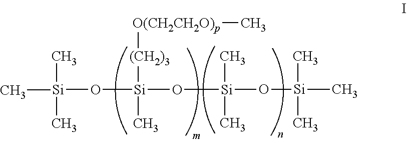

wherein the ratio of wt. % of non-siloxane to molecular weight of the amphiphilic dimethylsiloxane block copolymer is from about 0.0025 to about 0.2. In some embodiments, the ratio of wt. % of non-siloxane to molecular weight of the amphiphilic dimethylsiloxane block copolymer is from about 0.02 to about 0.15. In other embodiments, the ratio of wt. % of non-siloxane to molecular weight of the amphiphilic dimethylsiloxane block copolymer is from about 0.05 to about 0.13.

### Methods of Making Compositions

In a further aspect, the disclosure relates to methods of preparing the compositions disclosed herein, the method comprising the steps of: (a) contacting the rubber with a solution of the amphiphilic dimethylsiloxane block copolymer; and (b) removing the excess solution. In some embodiments, the contacting step occurs for up to about 1 to about 6 hours. In other embodiments, the method further comprises the step of (c) vacuum drying the composition. In yet other embodiments, the polymer comprising the rubber is contacted with a solution of the amphiphilic dimethylsiloxane block copolymer for about 1.5 hours, about 3 hours, or about 5 hours. In yet other embodiments, the polymer comprising the rubber is contacted with a solution of the amphiphilic dimethylsiloxane block copolymer for about 5 hours. In some embodiments, the solution comprises an organic solvent. In other embodiments, the organic solvent is toluene. In some embodiments, the solution of the amphiphilic dimethylsiloxane block copolymer is at a concentration of about 1 w/v % to about 10 w/v %. In other embodiments, the solution of the amphiphilic dimethylsiloxane block copolymer is at a concentration of about 5 w/v %. In yet other embodiments, the compositions comprising an amphiphilic dimethylsiloxane block copolymer embedded with a polymer comprising a rubber obtainable by any of the methods of making disclosed herein are contemplated.

### Methods of Use of Compositions

In yet a further aspect, the disclosure relates to methods of processing an aqueous liquid composition comprising a biologically active large molecule, the method comprising the steps of: (a) providing any of the amphiphilic dimethylsiloxane block copolymer embedded within a rubber compositions disclosed herein in the form of a tubing; and (b) pumping the aqueous liquid composition through the tubing. In some embodiments, the biologically active large molecule is prone to aggregation. In other embodiments, the methods further comprise the step of: (c) filtering the aqueous liquid composition. In yet other embodiments, the filtering is tangential flow filtration. In some embodiments, the tangential flow filtration is characterized by a flux in liters/meters²/hour (L/m²/h), and wherein the flux remains the same. In other embodiments, the flux remains the same or decreases up to 5 L/m²/h. In other embodiments, the flux remains the same or decreases up to 3 L/m²/h. In yet other embodiments, the flux remains the same or decreases up to 1 L/m²/h. In some embodiments, the duration of flux is reduced compared to tangential flow filtration through an unmodified tubing without the embedded amphiphilic dimethylsiloxane block copolymer.

In yet a further aspect, the disclosure relates to methods of reducing aggregation of a biologically active large molecule in an aqueous liquid, the method comprising contacting the aqueous liquid with any of the amphiphilic dimethylsiloxane block copolymers embedded within a rubber compositions disclosed herein, wherein the method results in reduced aggregation of the biologically active large molecule compared with contacting the aqueous liquid with a rubber lacking the amphiphilic dimethylsiloxane block copolymer. In some embodiments, the aggregation of the biologically active large molecule is reduced by about 70% to about 99%. In other embodiments, the biologically active large molecule is an antibody, and wherein the aggregation of the antibody is reduced by about 80%. In yet other embodiments, the biologically active large molecule is a growth hormone, and wherein the aggregation of the growth hormone is reduced by about 95%. In some embodiments, the biologically active large molecule is a protein. In other embodiments, the biologically active large molecule is an antibody, antibody conjugate, antibody fragment or fusion protein. In some embodiments, the biologically active large molecule is at a concentration of about 0.5 to about 5 mg/mL. In other embodiments, the biologically active large molecule is at a concentration of about 1 mg/mL. In yet other embodiments, the aqueous liquid is a pharmaceutical composition.

### Item List

Amongst others, the present disclosure relates to the following specific embodiments:
1. A composition comprising an amphiphilic dimethylsiloxane block copolymer embedded within a rubber, wherein the rubber has an elongation at break greater than about 140%.
2. The composition of item 1, wherein the rubber is a silicone rubber.
3. The composition of item 2, wherein the silicone rubber is a platinum cured silicone rubber.
4. The compositions of item 1, wherein the rubber is an ethylene propylene diene monomer rubber.
5. The composition of item 4, wherein the ethylene propylene diene monomer rubber is a vulcanized ethylene propylene diene monomer rubber.
6. The composition of item 4 or item 5, wherein the ethylene propylene diene monomer rubber comprises ethylene propylene diene monomer rubber particles encapsulated in a polypropylene matrix.
7. The composition of any one of the preceding items, wherein the composition is in the form of a solid composition.
8. The composition of any one of the preceding items, wherein the composition is in the form of an elastomeric composition.
9. The composition of any one of the preceding items, wherein the composition is in the form of a tubing.
10. The composition of any one of the preceding items, wherein the amphiphilic dimethylsiloxane block copolymer comprises blocks of ethylene oxide, acrylic acid, or vinyl alcohol.
11. The composition of any one of the preceding items, therein the amphiphilic dimethylsiloxane block copolymer comprises blocks of ethylene oxide.
12. The composition of any one of the preceding items, wherein the composition comprises from about 0.1 w/w % to about 5 w/w % of the amphiphilic dimethylsiloxane block copolymer.
13. The composition of any one of the preceding items, wherein the composition comprises from about 0.5 w/w % to about 1.5 w/w % of the amphiphilic dimethylsiloxane block copolymer.
14. The composition of any one of the preceding items, wherein the amphiphilic dimethylsiloxane block copolymer comprises a dimethylsiloxane (ethylene oxide) block copolymer.
15. The composition of item 14, wherein the dimethylsiloxane (ethylene oxide) block copolymer comprises from about 25 to about 30 wt. % ethylene oxide.
16. The composition of item 14, wherein the dimethylsiloxane (ethylene oxide) block copolymer comprises from about 30 to about 35 wt. % ethylene oxide.
17. The composition of item 14, wherein the dimethylsiloxane (ethylene oxide) block copolymer comprises from about 60 to about 70 wt. % ethylene oxide.
18. The composition of item 14, wherein the dimethylsiloxane (ethylene oxide) block copolymer comprises from about 75 to about 85 wt. % ethylene oxide.
19. The composition of item 18, wherein the dimethylsiloxane (ethylene oxide) block copolymer comprises about 80 wt. % ethylene oxide.
20. The composition of any one of the preceding items, wherein the amphiphilic dimethylsiloxane block copolymer comprises a compound of formula I:

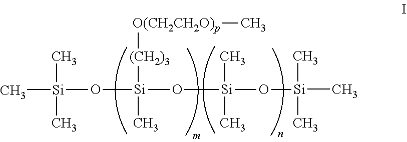

wherein the ratio of wt. % of non-siloxane to molecular weight of the amphiphilic dimethylsiloxane block copolymer is from about 0.0025 to about 0.2.
21. The composition of item 20, wherein the ratio of wt. % of non-siloxane to molecular weight of the amphiphilic dimethylsiloxane block copolymer is from about 0.02 to about 0.15.
22. The composition of item 21, wherein the ratio of wt. % of non-siloxane to molecular weight of the amphiphilic dimethylsiloxane block copolymer is from about 0.05 to about 0.13.
23. A method of preparing the composition of any one of the preceding items, the method comprising the steps of:
   (a) contacting the rubber with a solution of the amphiphilic dimethylsiloxane block copolymer; and
   (b) removing the excess solution.
24. The method of item 23, wherein the contacting step is for up to about 1 to about 6 hours.
25. The method of either item 23 or item 24, further comprising the step of:
   (c) vacuum drying the composition.
26. The method of any one of items 23 to 25, wherein the polymer comprising the rubber is contacted with a solution of the amphiphilic dimethylsiloxane block copolymer for about 1.5 hours, about 3 hours, or about 5 hours.
27. The method of any one of items 23 to 26, wherein the polymer comprising the rubber is contacted with a solution of the amphiphilic dimethylsiloxane block copolymer for about 5 hours.
28. The method of any one of items 23 to 27, wherein the solution comprises an organic solvent.
29. The method of item 28, wherein the organic solvent is toluene.
30. The method of one of items 23 to 29, wherein the solution of the amphiphilic dimethylsiloxane block copolymer is at a concentration of about 1 w/v % to about 10 w/v %.
31. The method of item 30, wherein the solution of the amphiphilic dimethylsiloxane block copolymer is at a concentration of about 5 w/v %.
32. A composition comprising an amphiphilic dimethylsiloxane block copolymer embedded with a polymer comprising a rubber obtainable by the method of any one of items 23 to 31.
33. A method of processing an aqueous liquid composition comprising a biologically active large molecule, the method comprising the steps of:
   (a) providing the composition of any one of items 1 to 22 or item 32 in the form of a tubing; and
   (b) pumping the aqueous liquid composition through the tubing.
34. The method of item 33, wherein the biologically active large molecule is prone to aggregation.
35. The method of any one of items 33 to 34, further comprising the step of:
   (c) filtering the aqueous liquid composition.
36. The method of item 35, wherein the filtering is tangential flow filtration.
37. The method of any one of items 35 to 36, wherein the tangential flow filtration is characterized by a flux in liters/meters²/hour (L/m²/h), and wherein the flux remains the same or decreases up to 5 L/m²/h.
38. The method of item 37, wherein the flux remains the same or decreases up to 3 L/m²/h.
39. The method of item 38, wherein the flux remains the same or decreases up to 1 L/m²/h.
40. The method of any one of items 36 to 39, wherein the duration of the tangential flow filtration is reduced compared to tangential flow filtration through an unmodified tubing without the embedded amphiphilic dimethylsiloxane block copolymer.
41. A method of reducing aggregation of a biologically active large molecule in an aqueous liquid, the method comprising contacting the aqueous liquid with the composition of any one of items 1 to 22 or item 32, wherein the method results in reduced aggregation of the biologically active large molecule compared with contacting the aqueous liquid with a rubber lacking the amphiphilic dimethylsiloxane block copolymer.
42. The method of item 41, wherein the aggregation of the biologically active large molecule is reduced by about 70% to about 99%.
43. The method of any one of items 41 to 42, wherein the biologically active large molecule is an antibody, and wherein the aggregation of the antibody is reduced by about 80%.
44. The method of any one of items 41 to 43, wherein the biologically active large molecule is a growth hormone, and wherein the aggregation of the growth hormone is reduced by about 95%.
45. The method of any one of items 33 to 44, wherein the biologically active large molecule is a protein.
46. The method of any one of items 33 to 45, wherein the biologically active large molecule is an antibody, antibody conjugate, antibody fragment or fusion protein.
47. The method of any one of items 33 to 46, wherein the biologically active large molecule is at a concentration of about 0.5 to about 5 mg/mL.
48. The method of item 47, wherein the biologically active large molecule is at a concentration of about 1 mg/mL.
49. The method of any one of items 33 to 48, wherein the aqueous liquid is a pharmaceutical composition.
50. A tubing comprising an amphiphilic dimethylsiloxane block copolymer embedded within a rubber, wherein the rubber has an elongation at break greater than about 140%.
51. The tubing of item 50, wherein the rubber is a silicone rubber.
52. The tubing of item 50, wherein the rubber is an ethylene propylene diene monomer rubber.
53. The tubing of item 52, wherein the ethylene propylene diene monomer rubber comprises ethylene propylene diene monomer rubber particles encapsulated in a polypropylene matrix.
54. The tubing of any one of items 50 to 53, wherein the amphiphilic dimethylsiloxane block copolymer comprises blocks of ethylene oxide, acrylic acid, or vinyl alcohol.
55. The tubing of any one of items 50 to 54, wherein the composition comprises from about 0.1 w/w % to about 5 w/w % of the amphiphilic dimethylsiloxane block copolymer.
56. The tubing of any one of items 50 to 55, wherein the composition comprises from about 0.5 w/w % to about 1.5 w/w % of the amphiphilic dimethylsiloxane block copolymer.
57. The tubing of any one of items 50 to 56, wherein the amphiphilic dimethylsiloxane block copolymer comprises a dimethylsiloxane (ethylene oxide) block copolymer.
58. The tubing of any one of items 50 to 57, wherein the amphiphilic dimethylsiloxane block copolymer comprises a compound of formula I:

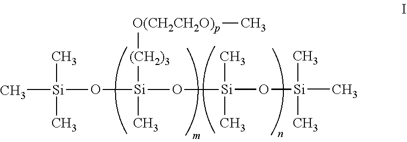

wherein the ratio of wt. % of non-siloxane to molecular weight of the amphiphilic dimethylsiloxane block copolymer is from about 0.0025 to about 0.2.

The following examples serve to illustrate the specific embodiments of the disclosure; however, should not be understood as restricting the scope of the disclosure.

### Examples

### Materials and Methods

Dimethylsiloxane (ethylene oxide) block copolymers were obtained from Gelest (Morrisville, NC, USA), including the copolymers with the product codes DBE-224, DBE-311, DBE-712, and DBE-814. The copolymers comprise a compound of formula I as disclosed herein and select properties are summarized in Table 1.

TABLE 1
Dimethylsiloxane (Ethylene Oxide) Block Copolymers

| | Wt % Non- | Molecular | Viscosity | Specific |
|---|---|---|---|---|
| Name | Siloxane | weight | Cst. | Gravity |
| DBE-224 | 25 | 10,000 | 400 | 1.02 |
| DBE-311 | 30-35 | 800-1,200 | 10 | 0.97 |
| DBE-712 | 60-70 | 600 | 20 | 1.01 |
| DBE-814 | 80 | 1,000 | 40-50 | 1.04 |

Other reagents were obtained as follows: 3-[Methoxy-(polyethyleneoxy)-propyl]-trimethoxysilane (PEG-silane) 90%, 6-9 PE-units from Abcr (Karlsruhe, Germany); barium chloride dihydrate from Gruessing (Filsum, Germany); di-sodium hydrogen phosphate dihydrate, ethanol and toluene from VWR; dimethylsulfoxide (DMSO) and hydrochloric acid (HCl) from Bernd Kraft (Duisburg, Germany); iodine sublime, potassium iodide, and sodium chloride (NaCl) from Merck (Darmstadt, Germany); L-histidine from AppliChem (Darmstadt, Germany); pluronics from BASF (Ludwigshafen, Germany); sodium dihydrogen phosphate from Glatt (Binzen, Germany); sodium dodecyl sulfate (SDS) and toluene D8 from Sigma Aldrich (St. Louis, MO, USA). Highly purified water produced with an Arium water purification system (Sartorius, Aubagne, France) was used for buffer preparation.

For the pumping studies, a monoclonal antibody (mAb, c=33.4 mg/mL) in 20 mM L-Histidine buffer pH 5.4 and a human growth hormone (HGH, c=10 mg/mL) in 10 mM sodium phosphate buffer pH 7.0 served as model proteins. Solutions of 1 mg/mL monoclonal antibody (mAb) in 20 mM histidine buffer pH 5.4 and 1 mg/ml human growth hormone (HGH) in 10 mM sodium phosphate buffer pH 7 were used. Prior to experiments, concentrations of mAb (¿=1.51) and HGH (ε=0.72) were verified via A280 with a Nanodrop 2000 (Thermo Fisher Scientific, Wilmington, NC, USA), and 1 mg/protein samples were filtered through a 0.2 μm PES sterile syringe filter (VWR, Radnor, USA).

Particle formation during pumping was quantified by flow imaging using a FlowCam 8100 (Fluid Imaging Technologies, Scarborough, USA) with 10× magnification cell (81 mm×700 mm) and turbidity using a Dr. Lange Nephla LPG 239 nephelometer (Hach Lange, Duesseldorf, Germany). The FlowCAM® 8100 was equipped with a 10× magnification cell (81 μm×700 μm). The following parameters were set for particle detection: sample volume of 150 μL, flow rate of 0.15 mL/min, auto image frame rate of 28 frames/s and a sampling time of 60 s. These settings lead to an efficiency value higher than 70%. Particles were identified using VisualSpreadsheet® 4.7.6 software (settings: 3 μm distance to the nearest neighbor; particle segmentation thresholds of 13 and 10 for the dark and light pixels) and results were displayed as the equivalent spherical diameter.

Protein adsorption on the tubing before and after 24 h of pumping was quantified based on the detachment of adsorbed protein by incubation with SDS followed by size-exclusion-HPLC quantification.

Elasticity and stress strain behaviour of the modified and non-modified tubing were evaluated using a Ta XT plus Texture Analyzer (Stable Micro Systems, Godalming, UK). Tubing pieces of 70 mm length were clamped into the apparatus resulting in 50 mm of tubing within the gap for stretching. Samples were pulled at 5 mm/min for 70 mm. Strain rate was set 0% at a prestress of 0.05 N/mm² to guarantee sufficient stretching. The elastic modulus was calculated from the slope of the stress-strain curve in the linear region between 0 and 10% strain.

Water contact angle measurements on tubings were performed using a Drop Shape Analyzer DSA25E (Kruess, Hamburg, Germany). A water drop of 3.0 μL was placed on the surface and the contact angle was evaluated based on a circle fit.

To detect the amount of incorporated copolymer in the tubing, silicone or EPDM rubber tubing was filled with 5% [w/v] DBE-712 in toluene and incubated for 5 h. After flushing with 100 mL ethanol and 100 mL highly purified water, toluene was slowly removed under vacuum for 12 h at 40° C. and 24 h at 60° C. using a VO 200 oven (Memmert, Schwabach, Germany). The amount of incorporated copolymer was determined via differential weighing. Weight differences for the EPDM rubber tubing after drying were corrected for a dried EPDM rubber tubing incubated with toluene only.

Residual toluene content was analysed by static headspace-gas chromatography-mass spectrometry (HS-GC-MS). An Agilent Technologies 7890B gas chromatograph (Waldbronn, Germany), equipped with an Agilent J&W DB-624 UI ultra-inert capillary column (6% cyanopropyl phenyl and 94% polydimethylsiloxane) 30 m×0.25 mm×1.4 μm and an Agilent Technologies 7010B triple quadrupole detector with high efficiency source was used for analysis. A tubing sample of 40 mm was placed into a 20 mL headspace vial, 20 μL of toluene D8 (1 mg/mL in DMSO) as internal standard was added, and the vial was closed tightly. After sealing, the sample was analysed by HS-GC-MS. The MS was operated in scan mode (m/z 45-120; EI 70 eV). The retention times and the molecule peaks of toluene (9.33 min, m/z 92) and toluene D8 (9.29 min, m/z 100) were used as qualifier ions and the base peaks m/z 91 and 98 as quantifier ions.

Statistical significance was evaluated based on an unpaired two-tailed t-test.

### Example 1. Rubber Compositions with Surface Modified Polyethyleneglycolsilane

20 cm pieces of Accusil pt-cured silicone tubings (ID 1.6 mm, wall 1.6 mm (Watson-Marlow, Falmouth, UK) were oxidized with O₂ plasma in a Zepto plasma oven (Diener electronic, Ebhausen, Germany). Vacuum was built up for 10 min, then the chamber was filled with oxygen for 2 min and plasma cleaning was performed at 0.3 mbar for 3 min with a power of 40 W. Immediately after treatment, the tubings were then incubated with (polyethyleneglycol)propyltrimethoxysilane having the general structure:

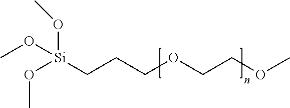

dissolved in toluene, ethanol, or dimethylsulfoxide (DMSO) at a concentration of 55 mg/mL for 1.5 hours at room temperature. Subsequently, the tubings were washed with 100 mL ethanol followed by 100 mL highly purified water to remove unbound PEG-silane. The organic solvent was evaporated using the VO 200 vacuum oven at 120° C. and 11 mbar for 45 minutes resulting in tubings with a (polyethyleneglycol)silane coating. When the modified tubings were used in a pumping environment, abrasion of the coatings was observed for all solvents and no reduction of biomolecule particle levels was observed.

### Example 2. Silicone Rubber Compositions Comprising Embedded Amphiphilic Dimethylsiloxane Block Copolymers

To incorporate the copolymer in the tubing a swelling/deswelling approach was developed. The choice of solvent for the copolymer was based on its tubing swelling ability to reach high levels of incorporated copolymer amounts. In preliminary experiments with ethanol and toluene the highest swelling efficacy was observed with toluene. The swelling was gone after drying. Toluene could be removed at 120° C. under vacuum for 45 min leading to a residual concentration of 4.6±0.6 μg/cm (ϑ0.0025±0.0003% [w/w]) toluene in the modified tubing. Prolonging the drying time to 24 h did not further reduce the residual toluene amount (5.4±0.5 μg/cm≙0.0030±0.0002% [w/w]).

To prepare the modified tubings, 20 cm pieces of Accusil pt-cured silicone tubings were filled with a solution of 2% (w/v), 5% (w/v) or 10% (w/v) dimethylsiloxane (ethylene oxide) block copolymer dissolved in toluene and incubated up to 1.5 hours, 3 hours or 5 hours at room temperature. The “% (w/v)” is calculated as the weight of copolymer dissolved in a volume of organic solvent. The ends were connected to 2 mL glass syringes filled with the polymer solution to avoid evaporation. Afterwards, tubings were rinsed with 100 mL ethanol and then 100 mL highly purified water. Obtained modified tubings were vacuum dried in the VO 200 oven at 120° C. and 11 mbar for 45 min to remove residual solvents. Modified tubing pieces were inserted in the pump head and were connected to unmodified tubing outside the pump head via Y-connectors.

The presence of the dimethylsiloxane block copolymer in the tubing was visualized by incubation of the tubing for 15 minutes in an iodine solution prepared from 2 g iodine sublime and 4 g potassium iodide in 100 mL highly purified water followed by rinsing with 100 mL highly purified water to remove residual staining solution.

Leaching of copolymers was quantified by measuring 1.5 mL pumped buffer and a mixture of a 375 μL iodine solution (2% iodine sublime and 4% (w/v) potassium iodide) and 187 μL of a 5% barium chloride solution. Obtained values were analysed based on a calibration curve. Leaching data is summarized in Table 2. Leaching data for the DBE-224 and DBE-311 copolymers were theoretically calculated because the copolymers are only sparingly soluble in water. The values were extrapolated based on the wt. % of non-siloxane (ethylene oxide/polyethylene glycol blocks) in comparison with DBE 712 and DBE-814.

TABLE 2
Copolymer leaching (per 1 pump cycle) in modified tubings

| Solvent | Modification | Leaching [ppm] |
|---|---|---|
| Toluene | DBE-712 2% (w/v) 1.5 hr | 0.010 |
| | DBE-712 10% (w/v) 1.5 hr | 0.049 |
| | DBE-712 5% (w/v) 1.5 hr | 0.026 |
| | DBE-712 5% (w/v) 3 hr | 0.074 |
| | DBE-712 5% (w/v) 5 hr | 0.090 |
| | DBE-224 5% (w/v) 5 hr | 0.008 |
| | | (theoretically calculated) |
| | DBE-311 5% (w/v) 5 hr | 0.025 |
| | | (theoretically calculated) |
| | DBE-814 5% (w/v) 5 hr | 0.068 |

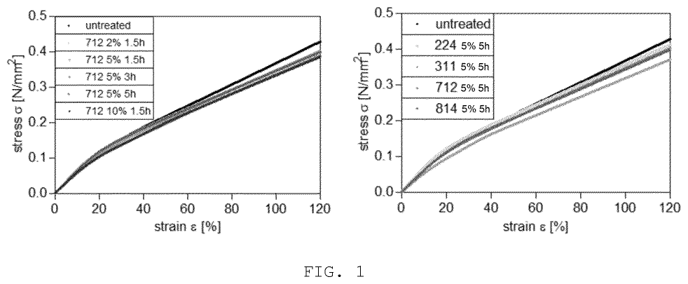

Embedding the dimethylsiloxane block copolymers in the rubber tubings had no impact on the mechanical stability of the tubings as shown in the stress-strain curves for modified and unmodified rubber tubings as depicted in FIG. 1. Stress-strain was measured with the 70 mm, 1.6 internal diameter (ID) tubing fixed within the Ta XT plus Texture Analyzer. The resulting 5 cm in the gap was stretched with a speed of 5 mm/min and a distance 70 mm. Strain rate was set 0% at a prestress of 0.05 N/mm² to guarantee sufficient stretching. The elastic modulus was calculated from the slope of the stress-strain curve in the linear region between 0 and 10% strain.

Staining the tubings with iodine solution confirmed the successful incorporation of the copolymers. All modified tubings revealed strong yellow to brownish colouring before and after pumping compared to the untreated tubing. Additionally, all modified tubings exhibited a homogenous distribution of the copolymer throughout the entire tubing wall which was stable during pumping.

### Example 3. Pumping Studies with Silicone Rubber Compositions Comprising Embedded Amphiphilic Dimethylsiloxane Block Copolymers

A sample volume of 6 mL of buffer solution followed by an equal volume of 1 mg/mL monoclonal antibody, protein or human growth hormone solution formulated in said buffer solution was pumped via a Flexicon PD 12 peristaltic pump (Flexicon, Kent, UK) with a velocity of 180 rpm and acceleration of 60 for 1 hr through the tubings prepared in Example 2 which results in 500 passages of the sample through the 1.6 mm bore tubing (n=3). Before and after every sample, tubings were rinsed with 100 mL highly purified water.

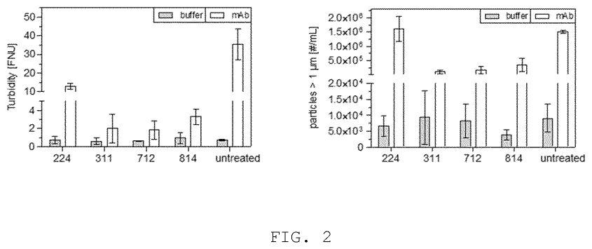

Turbidity measurements and particle quantification by flow imaging data for the buffer solution or the 1 mg/mL monoclonal antibody solution formulated in said buffer solution pumped through the modified or unmodified silicone rubber tubings are summarized in FIG. 2. The modified tubings were synthesized by contacting a 5% (w/v) DBE-224, DBE-311, DBE-712 or DBE-814 dimethylsiloxane block copolymer solution with the silicone rubber tubing for 5 hr as described in Example 2. Upon pumping the monoclonal antibody through the unmodified and modified tubings, turbidity and protein particle concentration increase were markedly less compared to untreated tubing. Incorporation of DBE-224 reduced turbidity from 35.3±8.3 to 13.0±1.4 FNU compared to the untreated tubing. The other modified tubings containing the dimethylsiloxane block copolymers DBE-311, DBE-712, and DBE-814 reduced the turbidity and particle concentration to approximately 3 FNU and 150,000 particles ≥1 μm per mL, respectively.

To identify the optimal parameters for modification, dimethylsiloxane block copolymer concentration in the incubation solution and incubation time were varied using the dimethylsiloxane block copolymer DBE-712. Incubation with 2% [w/v] DBE-712 for 1.5 h reduced turbidity only to 15.5±5.0 FNU while particle formation ≥1 μm per mL were unaffected. Incubation with 5% [w/v] DBE-712 decreased the turbidity and protein particle levels to 5.1±1.3 FNU and approx. 350,000±125,000 particles ≥1 μm per mL, respectively. Increasing the DBE-712 concentration further to 10% [w/v] did not additionally decrease protein particle formation and turbidity. Prolonging the incubation time from 1.5 to 3 and 5 h significantly reduced turbidity (p<0.05) to 2.5±0.5 FNU but had no effect on protein particle concentration. Therefore, modified tubings were generally prepared using 5% [w/v] for 5 h with DBE-712. This preparation led to an embedded mass of DBE-712 of 0.88±0.01% [w/w]. The 5% [w/v] DBE-712 for 5 h modified tubings generally suppressed monoclonal antibody adsorption to the silicone tubing. Even after 24 h of pumping, monoclonal antibody adsorption was not detectable on the 5% [w/v] DBE-712 for 5 h modified tubings compared to 5.2±0.4 mg/m² monoclonal antibody adsorbed to the untreated tubing. Additionally, water contact angles decreased to 76.5±0.8° before and 73.9±0.4° after 24 h pumping for the 5% [w/v] DBE-712 for 5 h modified tubings compared to 111.2±0.6° of the untreated tubing.

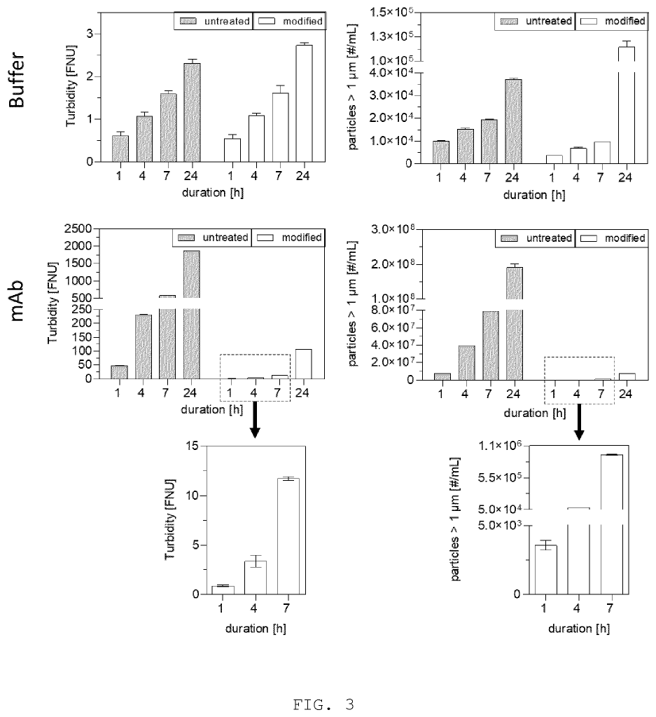

The stability data of the surface hydrophilicity over time for the buffer solution or the 1 mg/mL monoclonal antibody solution formulated in said buffer solution pumped through the modified or unmodified silicone rubber tubings are summarized in FIG. 3. The modified tubings were synthesized by contacting a 5% (w/v) DBE-712 dimethylsiloxane block copolymer solution with the silicone rubber tubing for 5 hr as described in Example 2. Especially in tangential flow filtration operations, pumping duration may last several hours. Therefore, the sustainability of the modified tubing was stressed by pumping for 24 hours (n=1). Particle ≥1 μm burden in buffer was comparable for modified and untreated tubing over 7 h and slightly higher in the modified tubing after 24 h (FIG. 3). Whereas pumping of the monoclonal antibody over 24 h with untreated tubing resulted in a linear increase of turbidity up to approx. 2,000 FNU and particle ≥1 μm level to nearly 200,000,000 per mL. Modifying the tubing reduced protein particle formation in a sustained manner over 24 h (100 FNU and 7,500,000 particles ≥1 μm/mL after 24 h, FIG. 3). The amount of copolymer detected in the buffer increased over time from 17.4, 48.0, 66.7, and 135.4 ppm after 1 h, 4 h, 7 h, and 24 h, respectively.

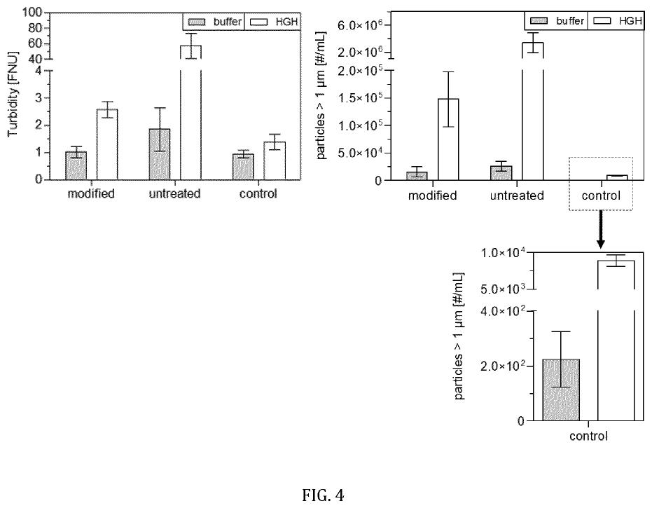

Turbidity measurements and particle quantification by flow imaging data for the buffer solution or the 1 mg/mL human growth hormone solution formulated in said buffer solution pumped through the modified or unmodified silicone rubber tubings are summarized in FIG. 4. The modified tubings were synthesized by contacting a 5% (w/v) DBE-712 dimethylsiloxane block copolymer solution with the silicone rubber tubing for 5 hr as described in Example 2. After 1 h pumping, 34.7±4.4 ppm of the dimethylsiloxane block copolymer was detected in buffer. Pumping human growth hormone for 1 h through unmodified silicone tubing resulted in an increase in turbidity from 1.4±0.3 to 57.4±15.8 FNU and formation of almost 3,500,000 particles ≥1 μm/mL. Modification of the tubing with 5% (w/v) DBE-712 for 5 h reduced human growth hormone particle formation with a turbidity after pumping of only approx. 3 FNU and 150,000 particles ≥1 μm/mL.

### Example 4. Silicone Rubber Compositions Comprising Embedded Poloxamers

Modified tubings were prepared as described in Example 2, but with poloxamers Pluronic L62 (Poloxamer 182), Pluronic L64 (Poloxamer 184), and Pluronic F68 (Poloxamer 188) instead of dimethylsiloxane (ethylene oxide) block copolymers. Pumping studies using a 1 mg/monoclonal antibody solution pumped through the modified tubings showed modest to no reduction in biomolecule particle formation. After pumping, poloxamer could not be detected in buffer. Modification with Pluronic L62 (Poloxamer 182) and Pluronic L64 (Poloxamer 184) did not show a significant (p>0.05) effect on turbidity and protein particle levels. In contrast, Pluronic F68 (Poloxamer 188) incorporation into the tubing did result in a reduction (p<0.01) in particle concentration ≥1 μm by approximately 65% but turbidity was also not significantly different from untreated tubing (p>0.05).

### Example 5. Ethylene Propylene Diene Monomer (“EPDM”) Rubber Compositions Comprising Embedded Amphiphilic Dimethylsiloxane Block Copolymers

Modified tubings were prepared as described in Example 2, but with Santoprene Thermoplastic Elastomer tubings (EPDM particles encapsulated in a polypropylene matrix) instead of Accusil pt-cured silicone tubings. These tubings are also referred to as thermoplastic vulcanizate (TPV) tubing. The modified tubings were synthesized by contacting a 5% (w/v) solution of DBE-712 dimethylsiloxane block copolymer solution with the EPDM rubber tubings for 5 hr. Modification of the tubing led to the incorporation of 0.93±0.01% [w/w] DBE-712.

### Example 6. Pumping Studies with EPDM Rubber Compositions Comprising Embedded Amphiphilic Dimethylsiloxane Block Copolymers

A sample volume of 6 mL of buffer solution followed by an equal volume of a 1 mg/mL monoclonal antibody solution in said buffer solution was pumped via a Flexicon PD 12 peristaltic pump (Flexicon, Kent, UK) with a velocity of 180 rpm and acceleration of 60 for 1 hr through the tubings prepared in Example 5. Before and after every sample, tubings were rinsed with 100 mL highly purified water.

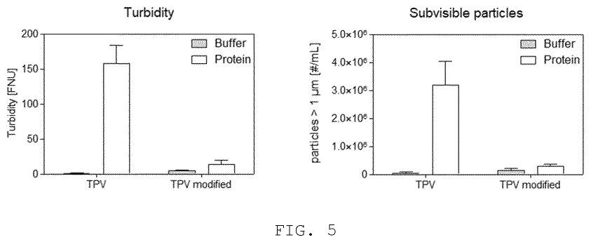

Turbidity measurements and particle quantification by flow imaging data for the buffer solution or the 1 mg/mL monoclonal antibody solution formulated in said buffer solution pumped through the modified or unmodified EPDM rubber tubings are summarized in FIG. 5. The modified tubings were synthesized by contacting a 5% (w/v) solution of DBE-712 dimethylsiloxane block copolymer solution with the EPDM rubber tubing for 5 hr as described in Example 5. After pumping of buffer, turbidity was slightly higher for the modified tubing compared to the unmodified tubing (4.2±1.1 FNU vs. 0.9±0.4 FNU) whereas particle concentrations ≥1 μm per mL were not significantly different (p>0.05). In pumped buffer, 10.2±5.9 ppm of DBE-712 was detected after 1 hour. After pumping monoclonal antibody, turbidity and particle concentration could be reduced by approximately 90% by modifying the EPDM rubber tubing with DBE-712 (FIG. 5). Overall, turbidity and protein particle concentration ≥1 μm per mL in untreated EPDM rubber tubing were significantly higher compared to untreated silicone tubing.

### Example 7. Tangential Flow Filtration Studies

Tangential flow filtration (TFF) was performed using a Repligen KR2i system (Marlborough, Massachusetts, United States). The system was equipped with a permeate and retentate scale and an auxiliary pump for buffer exchange. The system was operated at a constant transmembrane pressure (TMP) of 1.5 bar which was automatically regulated with a pressure valve based on the signals from the pressure transducers at retentate, permeate and feed outlets of the cassette holder. Membrane functionality of the flat sheet cassette membrane (Hystream, Low Fouling mPES, area of 0.02 m², 30 kDa cut off, Repligen) was evaluated by a normal water permeability test before each sample run. For the different tubing setups only the 34 cm tubing piece within the pump head was exchanged while the remaining connecting tubings were of Pharmampure tubing (Masterflex, Gelsenkirchen, Germany). A total of 100 mL 2 mg/mL monoclonal antibody in 10 mM His/HCl with 140 mM NaCl pH 7.2 were dialysed against the formulation buffer (40× volume; n=2; mean±span) at a feed flow rate of 100 mL/min. After experiments the system was cleaned using 0.2 N NaOH which was removed before experiments using highly purified water. Total particle concentration was evaluated by nephelometry and micro flow imaging (DPA4100, Brightwell Technologies Inc., Ottawa, Canada).

The results of the TFF experiments are summarized below in Table 3 for the 5% (w/v) DBE-712 silicone modified tubings as prepared in Example 2 (labeled “Silicone modified”) and the 5% (w/v) DBE-712 EPDM modified rubber tubings as prepared in Example 5 (labeled “TPV modified”). The modified tubings decreased protein particle formation leading to nearly no flux decrease. For the 5% (w/v) DBE-712 EPDM modified rubber tubings, even a reduction in TFF duration can be reached. The Flux LMH is liter/meter²/hour (L/m²/h).

TABLE 3
Results TFF Studies

| | Flux [LMH] | | Duration | Turbidity | Particles ≥1 μm |
|---|---|---|---|---|---|
| Material | Start* | End | [min] | [NTU] | [#/mL] |
| Silicone | 158 ± 3 | 153 ± 1 | 81 ± 2 | 3.3 ± 0.3 | 210,820 ± 92,395 |
| Silicone | 159 ± 1 | 159 ± 2 | 78 ± 1 | 1.7 ± 0.2 | 61,002 ± 29,754 |
| modified | | | | | |
| TPV | 134 ± 1 | 68 ± 2 | 126 ± 3 | 15.4 ± 3.5 | 454,552 ± 109,174 |
| TPV | 128 ± 0 | 127 ± 7 | 97 ± 2 | 3.6 ± 0.9 | 116,337 ± 28,918 |
| modified | | | | | |

*Flux at start represents the flux after the required transmembrane pressure (TMP) is reached.

1. A composition, wherein the composition is in the form of a tubing, comprising an amphiphilic dimethylsiloxane block copolymer embedded within a rubber, wherein the rubber has an elongation at break greater than about 140%.

2. The composition of claim 1, wherein the rubber is a silicone rubber.

3. The compositions of claim 1, wherein the rubber is an ethylene propylene diene monomer rubber.

4. The composition of claim 3, wherein the ethylene propylene diene monomer rubber comprises ethylene propylene diene monomer rubber particles encapsulated in a polypropylene matrix.

5. The composition of any one of the preceding claims, wherein the amphiphilic dimethylsiloxane block copolymer comprises blocks of ethylene oxide, acrylic acid, or vinyl alcohol.

6. The composition of any one of the preceding claims, wherein the composition comprises from about 0.1 w/w % to about 5 w/w % of the amphiphilic dimethylsiloxane block copolymer.

7. The composition of any one of the preceding claims, wherein the composition comprises from about 0.5 w/w % to about 1.5 w/w % of the amphiphilic dimethylsiloxane block copolymer.

8. The composition of any one of the preceding claims, wherein the amphiphilic dimethylsiloxane block copolymer comprises a dimethylsiloxane (ethylene oxide) block copolymer.

9. The composition of any one of the preceding claims, wherein the amphiphilic dimethylsiloxane block copolymer comprises a compound of formula I: 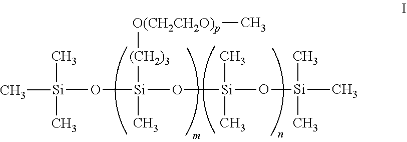
wherein the ratio of wt. % of non-siloxane to molecular weight of the amphiphilic dimethylsiloxane block copolymer is from about 0.0025 to about 0.2.

10. A method of preparing the composition of any one of the preceding claims, the method comprising the steps of:
(a) contacting the rubber with a solution of the amphiphilic dimethylsiloxane block copolymer; and
(b) removing the excess solution.

11. A composition comprising an amphiphilic dimethylsiloxane block copolymer embedded with a polymer comprising a rubber obtainable by the method of claim 10.

12. A method of processing an aqueous liquid composition comprising a biologically active large molecule, the method comprising the steps of:
(a) providing the composition of any one of claims 1 to 9 or claim 11; and
(b) pumping the aqueous liquid composition through the tubing.

13. A method of reducing aggregation of a biologically active large molecule in an aqueous liquid, the method comprising contacting the aqueous liquid with the composition of any one of claims 1 to 9, wherein the method results in reduced aggregation of the biologically active large molecule compared with contacting the aqueous liquid with a rubber lacking the amphiphilic dimethylsiloxane block copolymer.

14. The method of claim 13, wherein the biologically active large molecule is a protein, fusion protein, antibody, antibody conjugate, or antibody fragment.

15. The method of claim 13, wherein the aggregation of the biologically active large molecule is reduced by about 70% to about 99%.
